(19) United States
(12) Patent Application Publication
(10) Pub. No.: US 2008/0248973 A1
(43) Pub. Date: Oct. 9, 2008

(54) NUCLEIC ACID CHIP COUPLING SYSTEM AND METHOD OF USE

(75) Inventor: Sung-ouk JUNG, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/099,610

(22) Filed: Apr. 8, 2008

(30) Foreign Application Priority Data
Apr. 9, 2007 (KR) 10-2007-0034618

(51) Int. Cl. C40B 60/00

(52) U.S. Cl. 506/33

(57) ABSTRACT

Disclosed herein is a nucleic acid chip coupling system and a method of operating the nucleic acid chip coupling system. The nucleic acid chip coupling system comprises an upper case, a lower case, and a stirring shaft. The lower case is coupled with the upper case to form a space therein. The stirring shaft is rotatably coupled with one of the upper and lower cases and connected to one side of a wafer so as to rotate the wafer.

### CROSS REFERENCE TO RELATED APPLICATIONS

This application claims the benefit of Korean Patent Application No. 10-2007-0034618, filed on Apr. 9, 2007, and all the benefits accruing therefrom under 35 U.S.C. § 119, the entire contents of which are hereby incorporated by reference.

### BACKGROUND OF THE INVENTION

1. Field of the Invention

This disclosure relates to a nucleic acid chip coupling system, and more particularly, to a nucleic acid chip coupling system more efficiently immobilizing a probe nucleic acid on a wafer, and to a method of operating the nucleic acid chip coupling system.

2. Description of the Related Art

A single nucleic acid chip includes about 1,000 through to about 1,000,000 probe oligonucleotides, each oligonucleotide of known base sequence and containing about 8 to about 25 bases. In the nucleic acid chip, the probe oligonucleotides are attached to predetermined positions on a surface of a solid such as silicon, surface-modified glass, polypropylene, and/or activated polyacrylamide.

When a target nucleic acid fragment obtained from a sample is hybridized to the nucleic acid chip, different hybridization patterns are observed depending on the complementarity of base sequences between probe nucleic acids immobilized on the nucleic acid chip and the target nucleic acid fragment. The base sequence or genotype of a target nucleic acid, or a specific gene expression pattern of a sample, can be analyzed by observing and interpreting the hybridization pattern using various methods, for example an optical method or a radioactive chemical method.

Manufacturing and application technologies of nucleic acid chips are being developed by many universities and about 20 leading companies, including the US-based company Affymetrix, Inc.

Affymetrix, Inc. has commercialized a square DNA chip (1.28 cm×1.28 cm) to which 12,224 different base sequences are attached. In addition, Affymetrix, Inc. was the first company to sell research chips capable of detecting all human immunodeficiency virus (HIV) mutants resistant to HIV medicines.

GENECHIP, a microchip developed by Affymetrix, Inc., is capable of detecting gene variations associated with a disease through rapid human genome analysis within an hour. As such, GENECHIP is considered to be an important tool for the research and development of medicines.

Using a nucleic acid chip, even an infinitesimal sample can be analyzed, and base sequences in many portions of a target nucleic acid can be simultaneously diagnosed. A nucleic acid analysis system using a nucleic acid chip provides an inexpensive, simple, and rapid nucleic acid analysis method. Thus, the speed of nucleic acid analysis is increased by several tens to several hundreds of times as compared to other nucleic acid analysis methods that do not utilize a nucleic acid chip. Therefore, human genome projects can be performed rapidly, and the current cost of several dollars per base is reduced to several cents per base. In addition, the nucleic acid analysis system can be applied to various fields such as the diagnosis of inherited diseases, detection of mutants, diagnosis of cancer, detection of germs, analysis of gene expression, and new drug development.

A method of manufacturing a nucleic acid chip sequentially comprises: 1) a surface modification process for forming a membrane with amine groups or amide groups so as to immobilize probe nucleic acids on the surface of a wafer; 2) a spacer coupling process for coupling the probe nucleic acids to the membrane; 3) a capping process for removing the amine groups or amide groups which did not couple with the probe nucleic acids; 4) a deprotection process; 5) a monomer-coupling process for coupling the probe nucleic acids in a desired sequence; 6) a capping and oxidation process for removing reactive sites not coupled with the probe nucleic acids; and 7) a deprotection process.

Conventionally, the processes 2 through 5 are performed after immersing the wafer in a predetermined solution. FIG. 1 is a cross-sectional view illustrating a method of processing a wafer 30 using a previously known nucleic acid chip coupling system, which is an open system.

Referring to FIG. 1, a predetermined solution 20 is filled in a container 1 0 having a predetermined volume, and then the wafer 30 is immersed in the solution 20. As a result, the wafer 30 reacts with the solution 20 and the desired process is performed.

However, since an amidite coupling reaction between a probe nucleic acid and a substrate is sensitive to levels of moisture in the air, it is therefore important to control the ambient humidity and to maintain an inert atmosphere. Thus, since previously known nucleic acid chip coupling systems are open systems, the efficiency of a reaction in these nucleic acid chip coupling systems is not maximized.

In addition, since the previously known nucleic acid chip coupling systems use a superabundant solution (solvent), many nucleic acid molecules are disposed on a chip surface so as to increase the reaction concentration.

In addition, to maximize yield of the coupling reaction, the reaction solution should be simultaneously stirred in order to increase the collision frequency of the reactants. However, in the previously known nucleic acid chip coupling systems, the wafer 30 is immersed in the solution 20 and reacts with the solution 20 without stirring. Therefore, the reaction yield of the previously known systems is unsatisfactory.

### SUMMARY OF THE INVENTION

Disclosed herein is a more efficient nucleic acid chip coupling system to increase the reaction efficiency using a small quantity of solvent, and a method of making a nucleic acid chip using the nucleic acid coupling system.

According to one aspect of the present invention, there is provided a nucleic acid chip coupling system comprising an upper case, a lower case that can be coupled with the upper case to form a space therein, and a stirring shaft rotatably coupled with the upper case or the lower case, and wherein the stirring shaft can connect to a surface on one side of a wafer installed in the space so as to rotate the wafer.

According to another aspect of the present invention, there is provided a method of making a nucleic acid chip using the nucleic acid coupling system, the method comprising connecting a wafer to the stirring shaft; installing the wafer in the space formed by coupling the upper case and the lower case; injecting a solution comprising a nucleic acid through the injection hole; rotating the stirring shaft connected to the wafer such that the nucleic acid is coupled to the wafer; and removing the wafer to which the nucleic acid is coupled

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a method of processing a wafer using a prior art nucleic acid chip coupling system, which is an open system;

FIG. 2 is a cross-sectional view illustrating an exemplary embodiment of the nucleic acid chip coupling system disclosed herein;

FIG. 3 is a perspective view illustrating the relationship between a wafer and a stirring shaft in an exemplary embodiment; and

FIGS. 4A through 4D are exemplary cross-sectional views illustrating a method of operating the nucleic acid chip coupling system illustrated in FIG. 2 so as to form a nucleic acid chip.

### DETAILED DESCRIPTION OF THE INVENTION

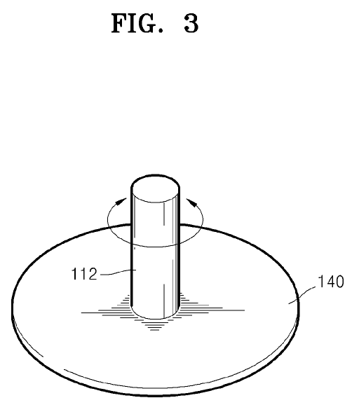

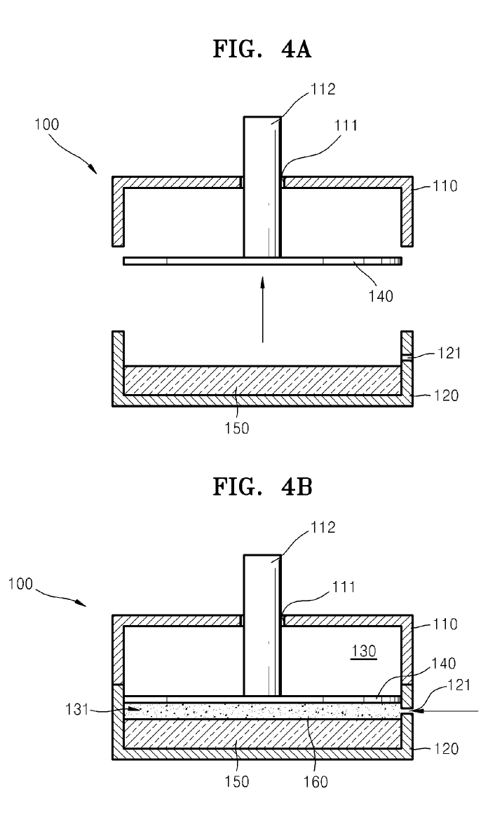

FIG. 2 is a cross-sectional view illustrating an exemplary configuration of a nucleic acid chip coupling system 100, and FIG. 3 is a perspective view of an exemplary embodiment illustrating the relationship between a wafer 140 and a stirring shaft 112 in an embodiment of the nucleic acid chip coupling system 100.

According to one embodiment, the nucleic acid chip coupling system 100 illustrated in FIGS. 2 and 3 comprises an upper case 110 and a lower case 120 that are coupled with each other to form a space 130 having a predetermined volume.

A through hole 111 is formed in the upper case 110. The stirring shaft 112 is rotatable and is passed through the upper case via the through hole 111. The stirring shaft 112 may rotate in both a clockwise and a counter clockwise direction.

For nucleic acid coupling reactions to a wafer 140 using the nucleic acid coupling system 100, the wafer 140 is installed in the space 130. One end of the stirring shaft 112 is connected to a surface on one side of the wafer 140 installed in the space 130. As a result, when the stirring shaft 112 rotates, the wafer 140 that is connected to the stirring shaft 112 also rotates. Various methods may be used to connect the stirring shaft 112 to the wafer 140, for example, the stirring shaft 112 can be detachable from the wafer 140, that is, not permanently fixed to the wafer 140.

An optional spacer 150, having a predetermined thickness, is can be disposed on a surface of the lower case 120. For nucleic acid coupling reactions using the nucleic acid coupling system 100, and the wafer 140 is spaced apart from the spacer 150 by a distance H, so that an injection space 131 is formed between the spacer 150 and the surface of the wafer 140 that is not connected to the stirring shaft 112. The surface of the spacer 150 adjacent to the injection space is flat, not rugged, so that the distance H can be uniform. If the distance H is not uniform, the reaction between the wafer 140 and a solution in the injection space cannot occur in a uniform manner across the entire surface of the wafer 140, thereby decreasing the reaction yield. The distance H is less than or equal to 1000 μm, and specifically, the distance H may be from about 50 μm to about 1000 μm. Additionally, when an inner surface of the lower case 120 is flat, the lower case 120 produces the same effect as that of the spacer 150, and thus, the spacer 150 may be omitted.

Since the distance H is small, the injection space 131 is also small. Therefore, the volume of solution that may be injected into the injection space 131 is small.

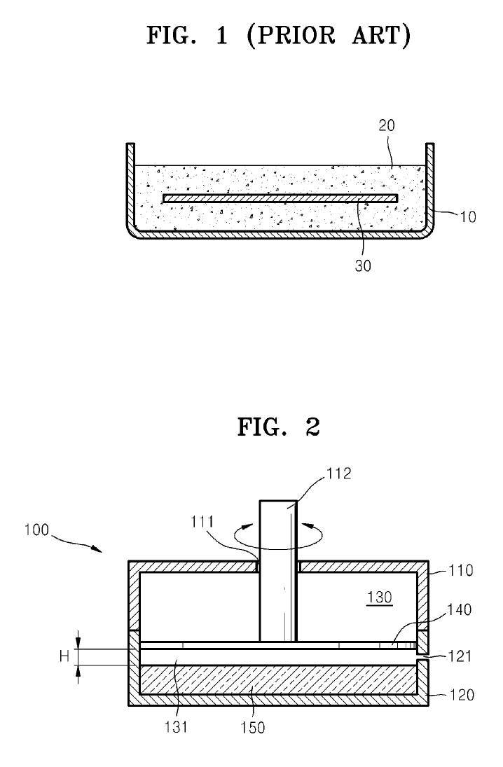

For example, when the prior art nucleic acid chip coupling system illustrated in FIG. 1 employs a solution of 10 ml, a nucleic acid chip coupling system according to the present invention employs a solution of 3 ml. From a quantitative point of view, the amount of solution required for the nucleic acid chip coupling system according to the present invention is remarkably reduced in comparison with that of the prior art nucleic acid chip coupling system illustrated in FIG. 1.

In order to inject a solution into the injection space 131, an injection hole 121 is formed in a side of the lower case 120. A solution that is injected through the injection hole 121 can spread throughout the injection space 131 through capillary action.

In FIG. 2, the stirring shaft 112 is passed through the through hole 111 formed in the upper case 110, and the spacer 150 is disposed on a surface of the lower case 120. However, the present invention is not limited thereto. Hence, it is possible for the stirring shaft 112 to be passed through a through hole 111 formed in the lower case 120, and the spacer 150 to be disposed on a surface of the upper case 110. In the latter instance, the injection hole 121 is formed in one side of the upper case 110.

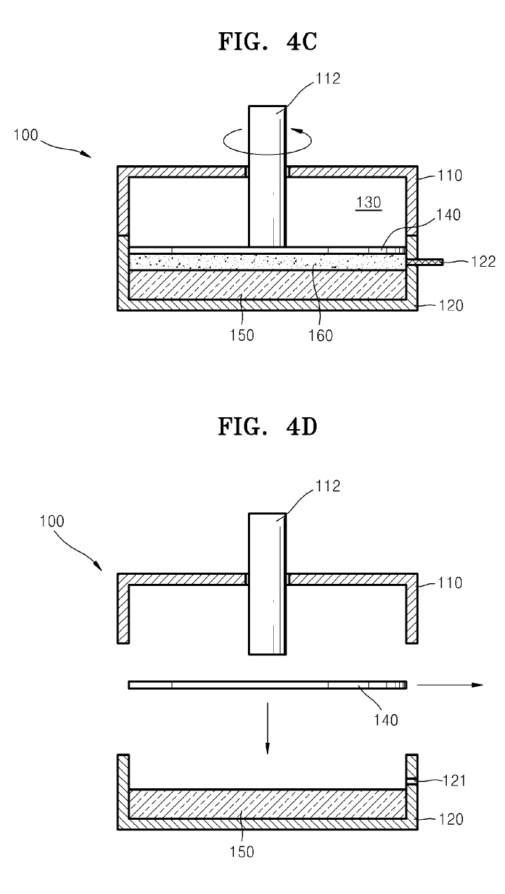

FIGS. 4A through 4D are exemplary views illustrating a method of operating the DNA chip coupling system illustrated in FIG. 2 so as to form a nucleic acid chip.

Referring to FIG. 4A, after the wafer 140 has been placed under the upper case 110, the stirring shaft 112 is moved down and connected to a surface on one side of the wafer 140. After that, the lower case 120 is moved toward the upper case 110 so as to be coupled with the upper case 110. As a result, as illustrated in FIG. 2, the wafer 140 is installed in the space 130 formed between the upper case 110 and the lower case 120. According to the present embodiment, the distance H between the spacer 150 and the wafer 140 may be adjusted as desired by vertically moving the stirring shaft 112 up or down to create the injection space 131 having a selected volume.

Referring to FIG. 4B, when a solution 160 is injected through the injection hole 121, with the wafer 140 positioned in the space 130 to form the injection space 131, the solution 160 spreads throughout the injection space 131 through capillary action. As such, the entire surface of the wafer 140 adjacent to the injection space is in contact with the solution 160.

Referring to FIG. 4C, the injection hole 121 is plugged by a shield 122 so as to prevent the solution 160 from flowing out of the injection space 131. After that, the stirring shaft 112 is rotated in a counter clockwise direction as shown by the arrow, resulting in rotating the wafer 140 in the solution 160. As a result, the reaction yield is increased. Also, the reaction time used can be flexibly set depending on reaction conditions. An exemplary reaction time is about 30 minutes. The reaction yield between the wafer 140 and the solution 160 can be changed by either adjusting the rotation direction (clockwise or counter clockwise), or the speed of the stirring shaft 112.

After the process as illustrated in FIG. 4C has been performed, the wafer 140 is separated from the shaft 112, as shown in FIG. 4D. The separation of the wafer 140 from the shaft 112 is conducted in reverse of the order used to assemble the nucleic acid chip coupling system as in the process illustrated in FIG. 4A.

As described above, the inventive nucleic acid chip coupling system and the method of operating the nucleic acid chip coupling system as described herein have the following effects.

First, by placing the wafer in a closed system provided by the upper case and the lower case, the wafer is not affected by humidity from outside the system. Therefore, an inert atmosphere can be maintained.

Second, since the solution is injected only into the space between the wafer and the spacer, the reaction concentration of a given amount of available reagent can be increased since only a small amount of the solution is necessary.

Third, since the wafer is rotated using the stirring shaft, the reaction yield between the wafer and the solution is increased.

Fourth, since the coupling system is a closed system, evaporation of the solution is prevented.

Fifth, since only one side of the wafer comes into contact with the solution, the other side of the wafer is not contaminated.

The terminology used herein is for the purpose of describing particular embodiments only and is not intended to be limiting of the invention. The terms “a” and “an” do not denote a limitation of quantity, but rather denote the presence of at least one of the referenced item. The term “or” means “and/or”. The terms “comprising”, “having”, “including”, and “containing” are to be construed as open-ended terms (i.e. meaning “including, but not limited to”).

It will be understood that when an element or layer is referred to as being “on,” “interposed,” “disposed,” or “between” another element or layer, it can be directly on, interposed, disposed, or between the other element or layer or intervening elements or layers may be present.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Unless defined otherwise, technical and scientific terms used herein have the same meaning as is commonly understood by one of skill in the art to which this invention belongs.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A nucleic acid chip coupling system comprising:
an upper case;
a lower case that can be coupled with the upper case to form a space therein; and
a stirring shaft rotatably coupled with the upper case or the lower case, wherein the stirring shaft can connect to a surface on one side of a wafer installed in the space so as to rotate the wafer.

2. The nucleic acid chip coupling system of claim 1, wherein the upper or lower case comprises at least one injection hole through which a solution is injected into the space.

3. The nucleic acid chip coupling system of claim 2, further comprising a spacer disposed on a surface of the upper case or a surface of the lower case.

4. The nucleic acid chip coupling system of claim 3, wherein the injection hole is formed in the upper case or in the lower case such that a solution can be directly injected into an injection space formed between a wafer installed in the space formed by the coupled upper case and lower case and the spacer.

5. The nucleic acid chip coupling system of claim 4, wherein a distance between the wafer and the spacer ranges from about 50 μm to about 1000 μm.

6. The nucleic acid chip coupling system of claim 1, wherein the stirring shaft rotates in a clockwise direction or in a counter clockwise direction.

7. A method of making a nucleic acid chip using the nucleic acid chip coupling system of claim 2, the method comprising:
connecting a wafer to the stirring shaft;
installing the wafer in the space formed by coupling the upper case and the lower case;
injecting a solution comprising a nucleic acid through the injection hole;
rotating the stirring shaft connected to the wafer such that the nucleic acid is coupled to the wafer; and
removing the wafer to which the nucleic acid is coupled.

8. The method of claim 7, wherein the injected solution spreads through the injection space and across the surface of the wafer through capillary action.

9. The method of claim 7, further comprising plugging the injection hole with a shield to prevent the solution from flowing out of the space after injection of the solution.
